(19) United States
(12) Patent Application Publication
(10) Pub. No.: US 2007/0094978 A1
(43) Pub. Date: May 3, 2007

(54) Flooring material

(75) Inventors: Tomas Svanholm, Alvsjo (SE); Johan Blix, Bromma (SE); Kee Jong Lee, Singapore (SG)

Correspondence Address: AKZO NOBEL INC., INTELLECTUAL PROPERTY DEPARTMENT, 120 WHITE PLAINS ROAD 3RD FLOOR, TARRTOWN, NY, 10591, US

(73) Assignee: AKZO NOBEL COATINGS INTERNATIONAL B.V., Arnhem (NL)

(21) Appl. No.: 11/520,220

(22) Filed: Sep. 13, 2006

Related U.S. Application Data
(60) Provisional application No. 60/724,301, filed on Oct. 7, 2005.

(51) Int. Cl. B32B 7/02; E04B 9/00

(52) U.S. Cl. 52/480; 428/215

(57) ABSTRACT

The invention relates to a wood based flooring material having an upper surface and a backing surface, the wood based flooring material comprising one or more layers, wherein the backing surface has a coating of a thermoplastic composition, wherein the thermoplastic composition has a ratio elastic modulus G′ to viscous modulus G″, G′/G″, of less than or equal to about 5 at 0.001 Hz and 25° C. The invention also relates to a method of producing the flooring material.

The present invention relates to a wood based flooring material and a method of producing a wood based flooring material.

### BACKGROUND

Wood based flooring materials are commonly in the form of solid wood, laminate floor, or engineered flooring such as parquet flooring or veneered flooring. Laminate floor has usually a core of, e.g., MDF, HDF, and an upper decorative layer. Parquet flooring are usually in the form of layered structures having an upper layer of high quality wood, e.g. oak, and the other layers being made of other wood based material.

One common way of installing wood based wood based flooring materials is by gluing the individual parts, which are usually elongated pieces, onto a sub-floor, “gluing down”. There is usually at the same time an attachment made between each piece sideways by a tongue and groove system with or without a locking system. Alternatively, a common way is to make “floating” flooring by not gluing the pieces onto the sub-floor but only connect the pieces sideways by using, e.g., a tongue and groove system.

An advantage with gluing the pieces down is that the feeling when walking on the floor is “solid” and firm, a “glue down feeling”. The noise when, walking on the floor is also minimised. A disadvantage with gluing pieces down is that the wood based flooring material will not be able to move when the wood tends to swell or shrink depending on changes in the temperature and humidity in the surrounding air. This may form of a gap between individual pieces and/or other damages.

An advantage with not gluing the pieces down is that the wood based flooring material is free to swell and shrink when there are changes in the temperature and humidity in the surrounding air. A disadvantage with not gluing pieces down is that the flooring will often give a feeling of being “loose” or less solid and also often give a more pronounced noise when walked upon compared with the same wood based flooring material being glued down.

US 2005/188639 A1 and U.S. Pat. No. 6,818,286 B2 disclose a flooring panel with sound-proofing. A thermoplastic material is fixed with the underside of the panel.

WO 2004/103698 A1 discloses a layered material wherein a backing layer comprises expanded thermoplastic microspheres.

It is an object of the present invention to provide a wood based flooring material which provides the benefits of glued-down wood based flooring materials at the same time the benefits of floating wood based flooring materials are provided. The disadvantages of one or the other are also minimised.

### THE INVENTION

The above-mentioned objects are achieved by a wood based flooring material having an upper surface and a backing surface, the wood based flooring material comprising one or more layers, wherein the backing surface has a coating of a thermoplastic composition having a ratio elastic modulus G′ to viscous modulus G″, G′/G″, of less than or equal to about 5 at 0.001 Hz and 25° C.

All values of elastic modulus G′ and viscous modulus G″ used herein are those measured within the linear viscoelastic range.

By the term “wood based flooring material” is herein meant flooring material comprising solid wood as well as flooring material comprising another wooden material such as fibre board, e.g., MDF and HDF, chip board and particle board.

By the term “upper surface” is meant a surface intended to be visible. By the term “backing surface” is meant the surface not intended to be visible of the wood based flooring material.

The thermoplastic composition has suitably a property of being permanently deformed by an applied stress.

By the term “permanently deformed” is meant that more than 10%, suitably more than 25%, preferably more than 50%, most preferably more than 75%, of a deformation caused by an applied stress is not disappearing after the stress has been released.

Suitably, the thermoplastic composition has a plastic behaviour, by which is meant that when subjected to continuous stress, it behaves like a liquid.

The thermoplastic composition of the present invention has suitably such rheological properties at 25° C. giving enough cohesion which relates to internal strength, enough adhesion for sufficient bonding to another surface and enough viscous properties for enabling a substantially permanent deformation of a layer of the thermoplastic composition applied onto a backing surface.

The thermoplastic material has suitably no maximum of loss modulus tan δ (during a temperature sweep) in the ambient temperature range.

The ratio elastic modulus G′ to viscous modulus G″, G′/G″, at 0.001 Hz and 25° C., of the thermoplastic composition is suitably from about 0.1 to about 5, preferably less than or equal to about 2, also preferably from about 0.2 to about 2, most preferably less than or equal to about 1.5, also most preferably from about 0.3 to about 1.5. The ratio elastic modulus G′ to viscous modulus G″, G′/G″, at 1 Hz and 25° C., of the thermoplastic composition is suitably less than or equal to about 1000, also suitably from about 0.1 to about 1000, preferably less than or equal to about 100, also preferably from about 0.5 to about 100, most preferably less than or equal to about 50, also most preferably from about 1 to about 50. The elastic modulus G′ of the thermoplastic composition, at 0.001 Hz and 25° C., is suitably from about 10³ to about 10⁸ Pa, preferably from about 10⁴ to about 10⁷ Pa. The viscous modulus G″ of the thermoplastic composition, at 0.001 Hz and 25° C., is suitably from about 10³ to about 10⁸ Pa, preferably from about 10⁴ to about 10⁷ Pa. The elastic modulus G′ of the thermoplastic composition, at 1 Hz and 25° C., is suitably from about 10³ to about 10⁸ Pa, preferably from about 10⁴ to about 10⁷ Pa. The viscous modulus G″ of the thermoplastic composition, at 1 Hz and 25° C., is suitably from about 10³ to about 10⁸ Pa, preferably from about 10⁴ to about 10⁷ Pa.

There is also suitably a certain frequency in the frequency range up to about 10 Hz, suitably from about 0.0001 to about 10 Hz, where the elastic modulus G′ is equal to the viscous modulus G″. At 25° C., the elastic modulus G′ is equal to the viscous modulus G″ at a frequency of suitably less than about 10 Hz, preferably less than about 1 Hz, more preferably less than about 0.1 Hz, most preferably less than about 0.01 Hz.

The thermoplastic material is suitably tacky at 25° C. This enables adhesion of the wood based flooring material to a sub-floor.

The thermoplastic composition can be present as a continuous coating forming a layer on the backing surface of the wood based flooring material. Alternatively, it may be present as a partial coating on the backing surface. In the latter case, it may be coated in a pattern of which examples are spots, stripes, or a grid. Preferably, the thermoplastic composition is present as a continuous coating.

The thickness of the coating of the thermoplastic composition of the wood based flooring material is suitably from about 0.1 to about 10 mm, preferably from about 0.2 to about 5 mm, most preferably from about 0.4 to about 2 mm.

The thermoplastic composition suitably comprises a thermoplastic polymer belonging to the group of polyisobutene, homo- and copolymers of (meth)acrylic acid derivatives, polysiloxanes, thermoplastic rubbers such as styrenic block copolymers, polyurethanes and polyvinyl ethers.

The thermoplastic composition suitably comprises a thermoplastic polymer in an amount of from about 1 to about 100 weight %, preferably from about 5 to about 75 weight %, most preferably from about 10 to about 50 weight %.

The number average molecular weight, Mₙ, of the thermoplastic polymer is suitably from about 10.000 to about 1.000.000, preferably from about 25.000 to about 500.000.

The glass transition temperature of the thermoplastic polymer is suitably from about −100 to about 10° C., preferably from about −90 to about −10° C., most preferably from about −80 to about −30° C.

The thermoplastic composition suitably comprises a plasticiser in an amount of from 0 to about 50 weight %, preferably from about 1 to about 40 weight %, more preferably from about 5 to about 20 weight %. The choice of plasticiser depends on the thermoplastic polymer used. The plasticiser is suitably a mineral or synthetic oil.

A tackifying resin may also be further present in the thermoplastic composition. Examples of such tackifying resins are hydrocarbon resins and rosin.

The thermoplastic composition can either be free from filler or suitably comprise a filler. The thermoplastic composition suitably comprises from 0 to about 90 weight % of a. filler, preferably from about 1 to about 85 weight %, more preferably from about 10 to about 80 weight %. The filler can be an organic filler such as wood flour, starch or nutshell flour, or an inorganic filler such as kaolin, talc and chalk.

The wood based flooring material is suitably a layered wood based flooring material comprising two or more layers such as laminate floor and engineered flooring such as veneered flooring or parquet flooring. Preferably, the wood based flooring material is a parquet wood based flooring material suitably comprising an upper layer, a backing layer and a core layer.

The wood based flooring material suitably comprises a plastic or paper foil positioned on the applied thermoplastic composition coating. The function of the plastic or paper foil is preferably protective and it is preferably removed before the use of the wood based flooring material. Examples of such a wood based flooring material is a multi-layered structure comprising an upper layer, a core layer, a backing layer, a thermoplastic composition coating according to the present invention and a plastic or paper foil as the outermost layer.

The present invention also relates to a method of producing a wood based flooring material as described above wherein the thermoplastic composition is applied onto the backing surface of the wood based flooring material. The thermoplastic composition is suitably applied onto the backing surface of the wood based flooring material in a molten state by, e.g., extruding. Alternatively, the thermoplastic composition is suitably applied onto the backing surface of the wood based flooring material as a pre-fabricated sheet which is pressed onto the backing surface of the wood based flooring material, preferably during heating. The thermoplastic composition may alternatively be applied onto the backing surface of the wood based flooring material as part of an aqueous dispersion followed by evaporation of the water.

The invention will now further be described in connection with the following examples which, however, not should be interpreted as limiting the scope of the invention.

### EXAMPLE 1

A base parquet flooring material was provided comprising a core of spruce, an upper layer of hardwood and a backing layer of spruce. The thickness of the upper layer was 4 mm, the core layer 9 mm, and the backing layer 2 mm. A coating of a material comprising 25 weight % of polyisobutene, 8 weight % of mineral oil and 67 weight % of chalk was applied to the backing surface forming a continuous layer of 1 mm thickness. The polyisobutene had a T_{g} of −63° C. and a molecular weight, Mₙ, of 120.000. The material was applied by heat-pressing a pre-fabricated sheet onto the backing layer.

The viscoelastic properties of the material coated was separately measured. A Bohlin CS10 rheometer was used with 25 mm plate/plate measuring geometry. The sample between the plates was 1 mm thick. A suitable shear stress was at first determined for being within the linear viscoelastic range. A shear stress of 500 Pa was chosen. Oscillation measurements was then made as a frequency sweep to determine the elastic modulus G′ and the viscous modulus G″. Table 1. summarises the results.

TABLE 1

| Frequency | Elastic modulus, G′ | Viscous modulus, G″ | |
|---|---|---|---|
| (Hz) | (Pa) | (Pa) | G′/G″ |
| 0.001 | 45.000 | 53.000 | 0.85 |
| 1 | 560.000 | 130.000 | 4.3 |

The frequency at which G′ = G″ was 0.0013 Hz

The flooring material was laid onto a sub-floor of concrete. The noise level was measured by using a tapping machine and compared with the same base parquet wood based flooring material laid onto the same sub-floor and using a standard sound insulating foam mat. The flooring according to the present invention gave up to 18 dB lower noise in the frequency range 100 to 10.000 Hz than the reference floating flooring when walked upon and also a “glue-down feeling”.

### EXAMPLE 2

An identical base parquet flooring material as in Example 1 was provided. A coating of a material comprising 10 weight % of polyisobutene being the same as in Example 1, 16 weight % of mineral oil and 74 weight % of chalk was applied to the backing surface in the same way as in Example 1 forming a continuous layer of 1 mm thickness.

The viscoelastic properties of the material coated was separately measured in the same manner as in Example 1. Table 2. summarises the results.

TABLE 2

| Frequency | Elastic modulus, G′ | Viscous modulus, G″ | |
|---|---|---|---|
| (Hz) | (Pa) | (Pa) | G′/G″ |
| 0.001 | 2.300.000 | 2.000.000 | 1.1 |
| 1 | 7.300.000 | 250.000 | 29 |

The frequency at which G′ = G″ was 0.00098 Hz

The flooring material was laid onto a sub-floor of concrete and compared with a reference flooring as in Example 1. The flooring gave lower noise in the same extent as in Example 1 when walked upon and a “glue-down feeling”.

### EXAMPLE 3

The viscoelastic properties of a conventional parquet adhesive available on the market used for gluing down parquet, Parkett Elastic from Akzo Nobel, were also measured in the same manner as for the thermoplastic composition according to the invention. Table 3. summarises the results.

TABLE 3

| Frequency | Elastic modulus, G′ | Viscous modulus, G″ | |
|---|---|---|---|
| (Hz) | (Pa) | (Pa) | G′/G″ |
| 0.001 | 200.000 | 20.000 | 10 |
| 1 | 300.000 | 60.000 | 5 |

The viscous modulus was never higher than, or equal to, the elastic modulus in the frequency range up to 10 Hz. Thus, the elastic properties are very pronounced even at very low frequencies and the objectives of the present invention are not fulfilled.

1. Wood based flooring material having an upper surface and a backing surface, the wood based flooring material comprising one or more layers, wherein the backing surface has a coating of a thermoplastic composition having a ratio elastic modulus G′ to viscous modulus G″G′/G″, of less than or equal to about 5 at 0.001 Hz and 25° C.

2. Wood based flooring material according to claim 1, wherein the ratio elastic modulus G′ to viscous modulus G″, G′/G″, at 0.001 Hz and 25° C., of the thermoplastic composition is from about 0.3 to about 1.5.

3. Wood based flooring material according to claim 1, wherein the ratio elastic modulus G′ to viscous modulus G″, G′/G″, at 1 Hz and 25° C., of the thermoplastic composition is less than or equal to about 1000.

4. Wood based flooring material according to claim 1, wherein the elastic modulus G′ of the thermoplastic composition, at 0.001 Hz and 25° C., is from about 10³ to about 10⁸ Pa.

5. Wood based flooring material according to claim 1, wherein the viscous modulus G″ of the thermoplastic composition, at 0.001 Hz and 25° C., is from about 10³ to about 10⁸ Pa.

6. Wood based flooring material according to claim 1, wherein at 25° C., the elastic modulus G′ is equal to the viscous modulus G″ at a frequency of suitably less than about 0.1 Hz.

7. Wood based flooring material according to claim 1, wherein the thermoplastic composition has a property of being permanently deformed by an applied stress.

8. Wood based flooring material according to claim 1, wherein the coating of a plastic material has a thickness of from about 0.2 to about 5 mm.

9. Flooring according to claim 1, wherein the thermoplastic composition comprises a thermoplastic polymer having a glass transition temperature of from about −90 to about −10° C.

10. Wood based flooring material according to claim 1, wherein the thermoplastic composition comprises a thermoplastic polymer belonging to the group of polyisobutene, homo- and copolymers of (meth)acrylic acid derivatives, polysiloxanes, thermoplastic rubbers such as styrenic block copolymers, polyurethanes and polyvinyl ethers.

11. Wood based flooring material according to claim 1, wherein the thermoplastic composition comprises a thermoplastic polymer in an amount of from about 10 to about 50 weight %.

12. Wood based flooring material according to claim 1, wherein the thermoplastic composition comprises a plasticiser in an amount of from about 5 to about 20 weight %.

13. Wood based flooring material according to claim 1, wherein the thermoplastic composition comprises from about 10 to about 80 weight % of a filler.

14. Wood based flooring material according to claim 1, comprising a plastic or paper foil positioned on the applied thermoplastic composition layer.

15. Wood based flooring material having an upper surface and a backing surface, the wood based flooring material comprising one or more layers, wherein the backing surface has a coating of a thermoplastic composition having a ratio elastic modulus G′ to viscous modulus G″, G′/G″, of less than or equal to about 5 at 0.001 Hz and 25° C., the elastic modulus G′ of the thermoplastic composition, at 0.001 Hz and 25° C., is from about 10⁴ to about 10⁷ Pa, the viscous modulus G″ of the thermoplastic composition, at 0.001 Hz and 25° C., is from about 10⁴ to about 10⁷ Pa, the thermoplastic composition has a property of being permanently deformed by an applied stress.

16. Wood based flooring material according to claim 15, wherein the thermoplastic composition comprises a thermoplastic polymer in an amount of from about 10 to about 50 weight %.

17. Method of producing a wood based flooring material according to claim 1, comprising applying the thermoplastic composition onto the backing surface of the wood based flooring material.

18. Method according to claim 17, wherein the thermoplastic composition is applied onto the backing surface of the wood based flooring material in a molten state.

19. Method according to claim 17, wherein the thermoplastic composition is applied onto the backing surface of the wood based flooring material as a prefabricated sheet which is pressed onto the backing surface of the wood based flooring material

20. Method according to claim 17, wherein the thermoplastic composition is applied onto the backing surface of the wood based flooring material as part of an aqueous dispersion followed by evaporation of the water.
